(19) United States
(12) Patent Application Publication
(10) Pub. No.: US 2012/0041597 A1
(43) Pub. Date: Feb. 16, 2012

(54) FAN SPEED CONTROL SYSTEM AND METHOD

(75) Inventors: CHAO-KE WEI, Tu-Cheng (TW); YAO-TING CHANG, Tu-Cheng (TW)

(73) Assignee: HON HAI PRECISION INDUSTRY CO., LTD., Tu-Cheng (TW)

(21) Appl. No.: 12/862,714

(22) Filed: Aug. 24, 2010

(30) Foreign Application Priority Data
Aug. 12, 2010 (TW) 99126955

(51) Int. Cl. G05B 15/02

(52) U.S. Cl. 700/275

(57) ABSTRACT

A fan speed control system includes a fan, a hardware device, and a basic input/output system (BIOS) module. The BIOS module includes a memory unit, an initial power detecting unit, a searching unit, and a control unit. The memory unit stores a matching table between of initial power ranges and corresponding fan speed control curves. The initial power detecting unit is operable to detect the initial power of the hardware device. The searching unit is operable to read the matching table and search which fan speed control curve matches with the initial power of the hardware device. The control unit is operable to select the matching fan speed control curve to control a speed of the fan.

### CROSS-REFERENCE OF RELATED APPLICATIONS

Relevant subject matters are disclosed in two co-pending U.S. patent applications (Attorney Docket Nos. U.S. 34630, U.S. 34645), which are assigned to the same assignee as this patent application.

### BACKGROUND

1. Technical Field

The present disclosure relates to a fan speed control system and a fan speed control method.

2. Description of Related Art

In a computer system, one or more fans may be installed in the computer system to dissipate heat generated by some hardware devices, such as a hard disk drive (HDD). The fan speed of a fan is controlled by some fan speed control curves set in software under different conditions.

Referring to FIG. 1, the figure shows two fan speed control curves A and B. At the same temperature, the fan speed controlled by the curve A is greater than the fan speed controlled by the curve B. In other words, the curve A is used to control the fan to dissipate heat of a high powered hardware device, and the curve B is used to control the fan to dissipate heat of a low powered hardware device, which can save electricity. Nowadays, a fan speed control system is to use a basic input/output system (BIOS) module to detect what the hardware device is, and correspondingly select an appropriate fan speed control curve for the hardware device. When the hardware device is new, the BIOS module cannot detect what it is, therefore the BIOS can only select the fan speed control curve which controls the fan at the highest rotations per minute (RPM) speed state to make sure the computer system will continue to work normally. However, the new hardware device may not need to use the fan speed control curve which controls the fan at the highest RPM speed state, and other fan speed control curves may be more appropriate for the new device in terms of electricity-saving.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is a waveform chart of two common fan speed control curves.

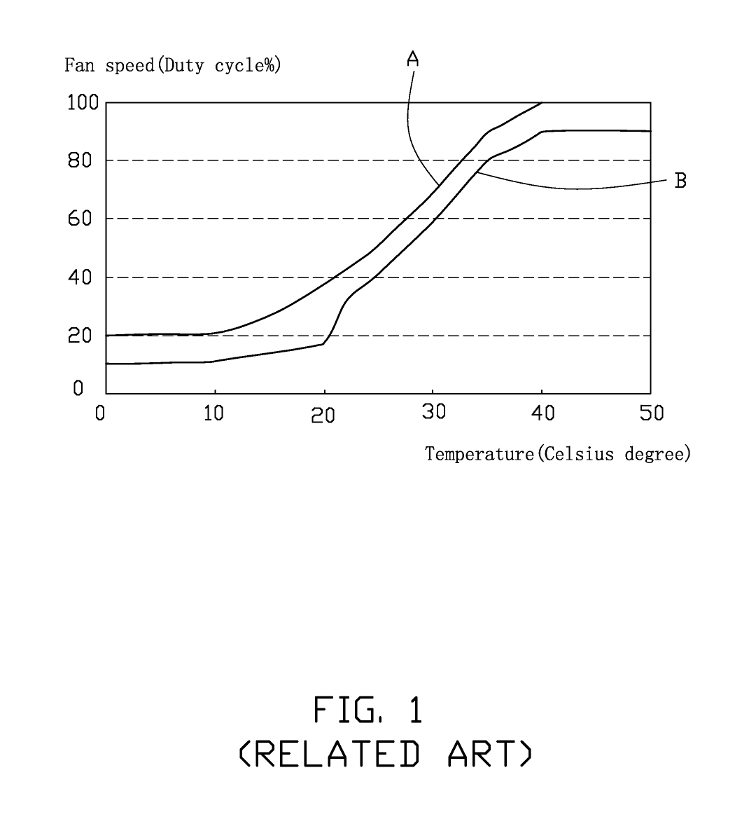

FIG. 2 is a block diagram of an embodiment of a fan speed control system.

FIG. 3 is a flowchart of an embodiment of a fan speed control method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

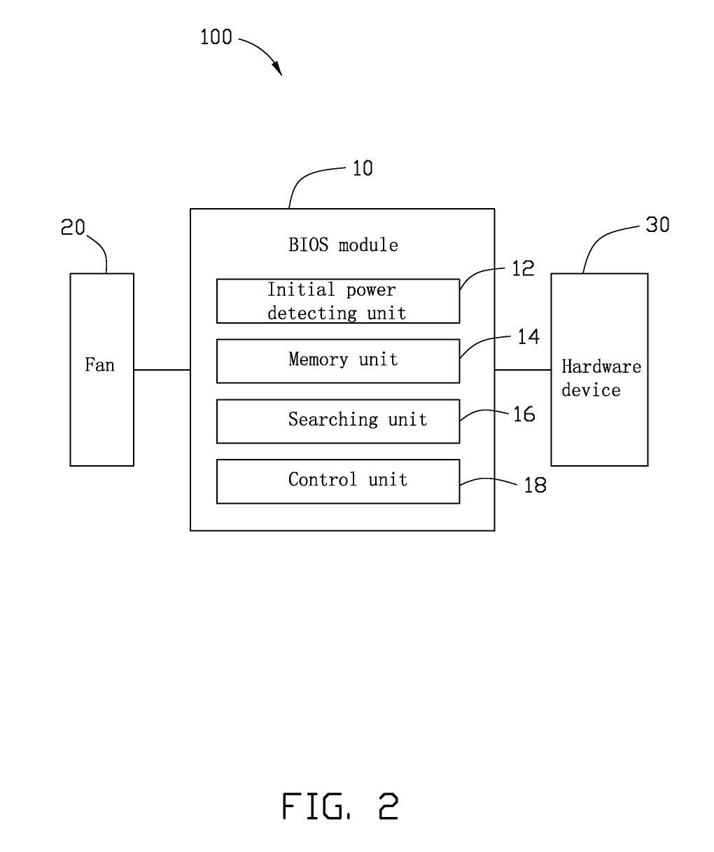

Referring to FIG. 2, an embodiment of a fan speed control system 100 includes a basic input/output system (BIOS) module 10, a fan 20, and a hardware device 30. The BIOS module 10 is used to initialize and identify system devices such as video display cards, keyboards, mice, hard disks, and other hardware devices when the computer system boots up. In other embodiments, the number of the fan 20 and the hardware device 30 may be more than one.

The BIOS module 10 includes an initial power detecting unit 12, a memory unit 14, a searching unit 16, and a control unit 18. The memory unit 14 stores a matching table of different initial power ranges and corresponding fan speed control curves, and each initial power range corresponds to a fan speed control curve. The following table shows an example of the matching table layout.

| | 0-8 W | 8-16 W | 16-24 W | . . . |
|---|---|---|---|---|
| Curve A | Y | N | | . . . |
| Curve B | N | Y | | . . . |
| Curve C | N | N | | . . . |
| . . . | . . . | . . . | | . . . |

Where, each cell of the first row of the table shows an initial power range of a hardware device (one cell also can show one initial power range of more than one hardware devices), each cell of the first column of the table shows a fan speed control curve. “Y” means matching, and “N” means not matching. For example, the curve “A” matches with the initial power range “0-8 W”. The matching table can be edit in the BIOS user interface. For example, if the computer system installs a new initial power range and/or needs to use a new fan speed control curve, operators can add the new initial power range and/or the new fan speed control curve in the matching table by the BIOS user interface.

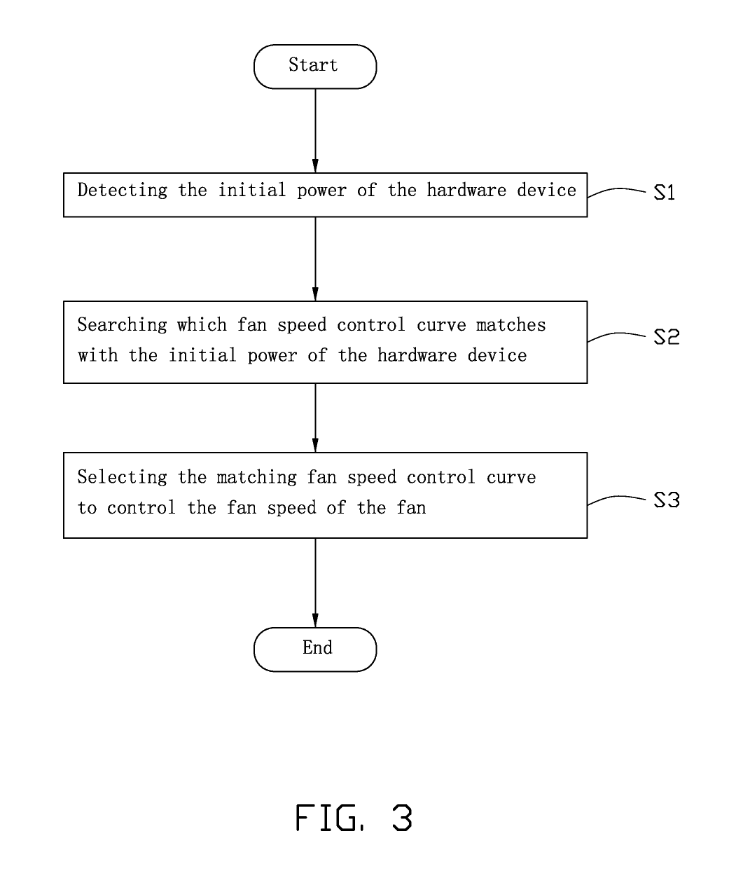

Referring to FIG. 3, an embodiment of a fan speed control method used in the fan speed control system 100 includes the following steps.

Step S1, the initial power detecting unit 12 detects the initial power of the hardware device 30.

Step S2, the searching unit 16 reads the matching table saved in the memory unit 14 and searches which fan speed control curve matches with the initial power of the hardware device 30, and then transmits matching information to the control unit 18.

Step S3, the control unit 18 selects the matching fan speed control curve to control the fan speed of the fan 20 according to the matching information.

The fan speed control system 100 or the fan speed control method saves a matching table between different initial power ranges and different fan speed control curves, detects the initial power of the hardware device 30 by the initial power detecting unit 12, searches an appropriate fan speed control curve by the searching unit 16, and then selects the matching fan speed control curve to control the fan speed of the fan 20 by the control unit 18, thereby whatever the hardware device 30 or the fan speed control curves are, the BIOS module 10 can select an appropriate fan speed control curve for the hardware device 30, which can save electricity.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A fan speed control system comprising:
a fan;
a hardware device having an initial power; and
a basic input/output system (BIOS) module comprising:
a memory unit storing a matching table of different initial power ranges and different fan speed control curves, and each of the initial power ranges corresponding to one of the fan speed control curves;
an initial power detecting unit operable to detect the initial power of the hardware device;
a searching unit operable to read the matching table and search which fan speed control curve matches with the initial power of the hardware device; and
a control unit operable to select the matching fan speed control curve to control a speed of the fan.

2. A fan speed control method used to control a fan, the fan is used to dissipating heat of a hardware device having an initial power, the fan speed control method comprising:
providing a memory unit to store a matching table of different initial power ranges and different fan speed control curves, wherein each of the initial power ranges corresponds to one of the fan speed control curves;
detecting the initial power of the hardware device;
reading the matching table and searching which fan speed control curve matches with the initial power of the hardware device; and
selecting the matching fan speed control curve to control a speed of the fan.
